(19) United States
(12) Patent Application Publication
(10) Pub. No.: US 2023/0311751 A1
(43) Pub. Date: Oct. 5, 2023

(54) Rear Vehicle Light Assistant Device

(71) Applicant: Keaton Williams, Plaquemine, LA (US)

(72) Inventor: Keaton Williams, Plaquemine, LA (US)

(21) Appl. No.: 18/183,252

(22) Filed: Mar. 14, 2023

Related U.S. Application Data
(60) Provisional application No. 63/325,819, filed on Mar. 31, 2022.

(51) Int. Cl. B60Q 1/50; B60Q 1/00; B60Q 5/00; B60Q 1/26

(52) U.S. Cl. CPC B60Q 1/535; B60Q 1/0023; B60Q 5/006; B60Q 1/2615

(57) ABSTRACT

The present invention relates to a rear vehicle light assistant device that provides an improved means to assist in alerting drivers of their proximity to other vehicles. The device is comprised of a body, a fastener, and a Bluetooth speaker. The fastener allows the device to be universally attached to a plurality of different vehicle rears and the Bluetooth speaker allows the driver to be notified of their proximity to other vehicles. The device is also comprised of at least one camera, at least one sensor, and at least one light which all allow for the detection and notification of other drivers in close proximity to the user's vehicle in order to avoid collision and potential injury. Further, the camera allows the user to obtain video footage in the circumstance that a collision occurs.

### CROSS-REFERENCE TO RELATED APPLICATION

The present application claims priority to, and the benefit of, U.S. Provisional Application No. 63/325,819, which was filed on Mar. 31, 2022, and is incorporated herein by reference in its entirety.

### FIELD OF THE INVENTION

The present invention relates generally to the field of rear vehicle light assistants. More specifically, the present invention relates to a rear vehicle light assistant device that is comprised of a body, a fastener, and a Bluetooth speaker. In the preferred embodiment, the device may be universally attached to a plurality of different vehicle rears such as, but not limited to, a spoiler. The device is also comprised of at least one camera, at least one sensor, and at least one light which allow for the detection and notification of other drivers in close proximity to the user's vehicle. In this manner, the device can be applied to any vehicle such that the user and other drivers can be notified of their distance to each other in order to avoid collision and potential injury. Accordingly, the present disclosure makes specific reference thereto. Nonetheless, it is to be appreciated that aspects of the present invention are also equally applicable to other like applications, devices, and methods of manufacture.

### BACKGROUND

Vehicle accidents can happen when they are least expected. Accidents can be caused by the driver of another vehicle, or a driver can crash due to inclement weather. A common issue in accidents is being able to properly see the surroundings while driving. Some drivers fail to replace their taillights or do not know they are broken. When a vehicle's taillights are out, it will be nearly impossible to tell how close a vehicle is to another. Vehicles stopped at red lights or while driving during heavy inclement weather can be difficult to see when behind them. As a result, other motorists may accidentally rear end vehicles if they are unable to see them.

A vehicle accident can be disruptive to an individual's peace of mind, but it can also be costly. Paying for a mechanic to fix the vehicle or having to purchase a new vehicle can be frustrating and very expensive. The need for an alternative mode of transportation may be imperative and the search for a new vehicle can be timely. Further, if a driver is injured during the accident, the medical bills can build up and result in yet another expensive payment.

Being in a vehicle accident can also come with vehicle insurance troubles. Some drivers do not have vehicle insurance and if involved in an accident with one of these drivers, compensation may not be received. Some drivers may also make up a false statement as to their speed or lane position at the time of the accident in order to avoid compensating the other driver. If proper evidence of the faulty driver is not supplied to the insurance company, insurance premiums may be increased.

Therefore, there exists a long-felt need in the art for a rear vehicle light assistant device. There also exists a long-felt need in the art for a rear vehicle light assistant device that can sense the distance of other vehicles and alert a driver of their proximity to the vehicle in front of them. In addition, there exists a long-felt need in the art for a rear vehicle light assistant device that can record the moments before and during an accident in order for the user to have the evidence needed for an insurance claim. Finally, there exists a long-felt need in the art for a rear vehicle light assistant device that keeps all drivers on the road safe from collision or injury.

The subject matter disclosed and claimed herein, in one embodiment thereof, comprises a rear vehicle light assistant device. The device is comprised of a body, a fastener, and a Bluetooth speaker. In the preferred embodiment, the device may be universally attached to a plurality of different vehicle rears such as, but not limited to, a spoiler. The device is also comprised of at least one camera, at least one sensor, and at least one light which allow for the detection and notification of other drivers in close proximity to the user's vehicle. The device can be applied to any vehicle such that the user and other drivers can be notified of their distance to each other in order to avoid collision and potential injury.

In this manner, the rear vehicle light assistant device of the present invention accomplishes all of the foregoing objectives and provides an improved means to assist in alerting drivers of their proximity to other vehicles. Further, the device has a camera which can record the rear surroundings of the vehicle in order to provide video evidence in case of a collision. In addition, the device can keep drivers safe on the road to prevent collisions and injury.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rear vehicle light assistant device. The device is primarily comprised of a body, at least one fastener, and at least one Bluetooth speaker. In the preferred embodiment, the body is comprised of at least one camera, at least one light, at least one sensor, and at least one battery. During use, a sensor of the device detects the distance of a second vehicle behind the user's vehicle upon which the device is attached. A speed detector also detects the speed of the second vehicle. Once a threshold distance and/or a threshold speed has been exceeded, a light of the device begins flashing rapidly to alert the driver of the second vehicle they are about to rear-end the user's vehicle. The camera may begin recording when one or both thresholds have been reached/exceeded.

Accordingly, the rear vehicle light assistant device of the present invention is particularly advantageous as it notifies other drivers of their proximity to the user's vehicle in front of them and record a video if a collision occurs. In this manner, the rear vehicle light assistant device overcomes the limitations of existing rear vehicle light devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a rear vehicle light assistant device of the present invention in accordance with the disclosed architecture; and

FIG. 2 illustrates a perspective view of one potential embodiment of a rear vehicle light assistant device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a rear vehicle light assistant device. More specifically, there exists a long-felt need in the art for a rear vehicle light assistant device that can sense the distance of other vehicles and alert a driver of their proximity to the vehicle in front of them. In addition, there exists a long-felt need in the art for a rear vehicle light assistant device that can record the moments before and during an accident in order for the user to have the evidence needed for an insurance claim. Further, there exists a long-felt need in the art for a rear vehicle light assistant device that keeps all drivers on the road safe from collision or injury.

The present invention, in one exemplary embodiment, is comprised of a rear vehicle light assistant device. The device is primarily comprised of a body, at least one fastener, and at least one Bluetooth speaker. In the preferred embodiment, the body is comprised of at least one camera, at least one light, at least one sensor bar, and at least one battery. The camera may be any camera known in the art that allows the user to film their rear surroundings while driving. In this manner, the user can obtain video footage in the circumstance that a collision occurs. The light may be a colored light that is preferably red to warn other drivers when they are in close proximity of the user's vehicle. The sensor bar can be any sensor known in the art that allows the device to detect the proximity of other vehicles in order to alert those drivers of their distance. The battery may be any battery known in the art that allows the camera, the sensor, and the light to maintain proper function.

The body is secured to a vehicle with a fastener. The fastener is comprised of at least one mount base, at least one mount fixed to the top surface of the mount base, and at least one connector. The fastener can be any fastener known in the art that allows the body of the device to be securely fixed to the vehicle as to not fall off while the vehicle is in motion. In the preferred embodiment, the fastener is made from an elastic material. In that manner, the fastener is able to be stretched to be universally fitted onto any vehicle. The mount base and the mount allow the body of the device to be mounted onto the fastener. The connector secures the fastener to itself. The connector may be an adhesive material that is preferably waterproof to protect against weather or any other connector of the like.

In the preferred embodiment, the device is comprised of a Bluetooth speaker. The Bluetooth speaker is fixed inside the user's vehicle. In this manner, the user can be notified when another driver is approaching at a high rate of speed or if another driver is too close to the rear of their vehicle. In a differing embodiment, the Bluetooth speaker may notify the driver of their distance to items other than vehicles. In this manner, the device may be used as a backup indicator.

Accordingly, the rear vehicle light assistant device of the present invention is particularly advantageous as it notifies other drivers of their proximity to the user's vehicle in front of them and record a video if a collision occurs. In this manner, the rear vehicle light assistant device overcomes the limitations of existing rear vehicle light devices known in the art.

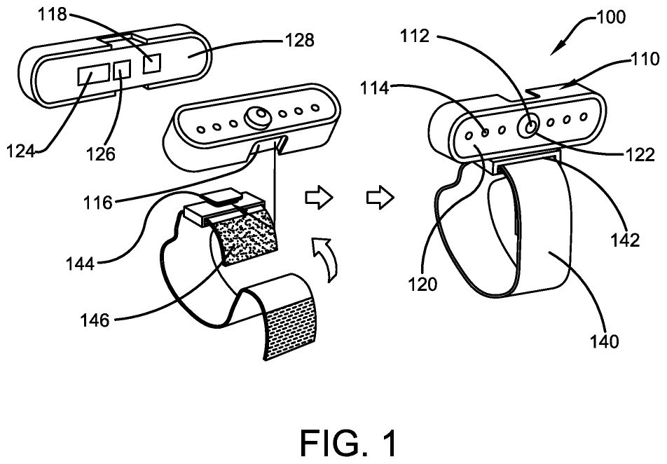

Referring initially to the drawings, FIG. 1 illustrates a perspective view of one potential embodiment of a rear vehicle light assistant device of the present invention in accordance with the disclosed architecture. The device 100 is primarily comprised of a body 110, at least one fastener 140, and at least one Bluetooth speaker 160. In differing embodiments, the body 110 may be a plurality of shapes such as, but not limited to, square, rectangle, triangle, circle, oval, pentagon, octagon, etc., or any shape that allows the device 100 to house the required parts which the device 100 is comprised of.

In the preferred embodiment, the body 110 may be manufactured from a metal material such as, but not limited to, sheet metal, stainless steel, galvanized steel, black steel, black iron, brass, nickel alloys, vehiclebon steel, duplex steel, copper nickel, titanium, cast iron, aluminum, etc. In a differing embodiment, the body 110 may be manufactured from any heat-resistant, rigid plastic known in the art such as, but not limited to, acrylic, polyvehiclebonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

In the preferred embodiment, the body 110 is comprised of at least one camera 112, at least one light 114, at least one sensor bar 120, at least one mount receiver 116, and at least one battery 124. The body 110 may also be comprised of a protective backing 128. The protective backing 128 may be any protective material known in the art such as, but not limited to, a foam or neoprene. The body 110 may also be comprised of a Bluetooth transmitter 118 which may be any Bluetooth transmitter known in the art.

The camera 112 may be any camera known in the art such as, but not limited to, a license plate camera, an RV backup camera, a bumper mounted camera, a low-profile camera, a side view camera, a dash camera, a waterproof/extreme environment camera, submersible underwater camera, etc. The camera 112 allows the user to record video footage in case of a collision. In a differing embodiment, the camera 112 is comprised of a radar speed detector 122 that allows the device 100 to detect the speed of a second device behind the first vehicle upon which the device 100 is secured to. The detector 122 may be any device known in the art that detects the speed of a rear-approaching vehicle.

In the preferred embodiment, the light 114 may be an LED light that is preferably waterproof to protect against weather. In differing embodiments, the light 114 may be any color such as, but not limited to, red, green, blue, yellow, orange, etc. The light 114 may have a plurality of blinking/flashing patterns.

In the preferred embodiment, the sensor bar 120 may be any sensor bar known in the art such as, but not limited to, a capacitive displacement sensor, an Eddy-current sensor, a hall effect sensor, an inductive sensor, a laser doppler vibrometer, a position encoder, a proximity sensor, etc. that detects the distance of a second vehicle from the first vehicle upon which the device 100 is attached. The distance detection may be done via laser or any other sensor-detecting means known in the art. The sensor bar's 120 function is to merely detect the presence of a second vehicle behind the user's vehicle.

In the preferred embodiment, the battery 124 may be comprised of at least one charging port 126 and allows for the battery 124 to be charged. The charging port 126 may be a USB port for charging the battery 124. In this manner, the user will be able to recharge the battery 124 so that the light 114 can maintain its function. In differing embodiments, the charging port 126 can be any charging port known in the art such as, but not limited to, a USB-A port, a USB-B port, a micro-USB port, a mini-USB port, a USB-C port, a lightning port, etc.

The body 110 is fixedly attached to the fastener 140. The fastener 140 may be manufactured of an elastic material to allow the device 100 to be universally attached to any vehicle. The fastener 140 can be made of any elastic material known in the art such as, but not limited to, a braided elastic, a knit elastic, a woven elastic, a clear elastic, a fold-over elastic, a swim elastic, etc. The fastener 140 may also be an adhesive fastener, a suction cup fastener, a magnetic fastener, or any fastener known in the art that allows the device 100 to removably attach to a vehicle. The fastener 140 is comprised of at least one connector 146, at least one mount base 142, and at least one mount 144.

In the preferred embodiment, the body 110 is fixedly attached to the fastener 140 by fitting the male mount 144 into the female mount receiver 116. The mount 114 and receiver 116 may be any reciprocating mount style known in the art. The mount 144 is fixedly attached to the mount base 142 and is made of a rigid, waterproof plastic. In differing embodiments, the mount may be made of a metal such as, but not limited to, sheet metal, stainless steel, galvanized steel, black steel, black iron, brass, nickel alloys, vehiclebon steel, duplex steel, copper nickel, titanium, cast iron, aluminum, etc. In one embodiment, the body 110 is fixedly secured to the mount 144 during the manufacturing process.

The connector 146 secures the fastener 140 to any vehicle known in the art. In the preferred embodiment, the connector 146 may be a hook and loop material that can withstand inclement weather conditions while a vehicle is in use. In differing embodiments, the connector 146 may be any connection member known in the art such as, but not limited to, an adhesive, a mechanical connector, etc.

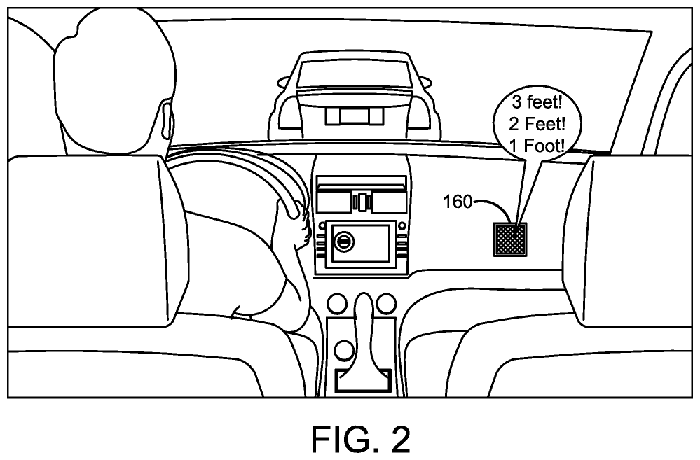

FIG. 2 illustrates a perspective view of one potential embodiment of a rear vehicle light assistant device 100 of the present invention in accordance with the disclosed architecture. In the preferred embodiment, the device 100 is comprised of a Bluetooth speaker 160. The Bluetooth speaker 160 is fixed inside the user's vehicle such that the user can be notified of the proximity of other vehicles. In the preferred embodiment, the Bluetooth speaker 160 can receive a signal from the Bluetooth transmitter 118 which is fixedly attached inside the body 110. The Bluetooth speaker 160 may be any Bluetooth speaker known in the art.

During use, the device 100 is positioned on a rear area of a first vehicle. As noted above, the fastener 140 may be attached to any portion of the rear area of the first vehicle. When the sensor bar 120 detects a second vehicle behind the user's vehicle that reaches or exceeds a threshold distance and at or above a threshold speed (detected by the speed detector 122 which is in electrical communication with the sensor 120), the light 114 will begin to rapidly blink. The light 114 may increase in blinking speed the closer the second vehicle gets to the user's vehicle. This serves to alert the driver of the second vehicle that they are approaching the user's vehicle at too fast of a speed. The threshold speed and threshold distance may be any speed and any distance that may be configured by the user. However, the threshold speed and threshold distance are preferably set to criteria that are present during/leading up to rear-end collisions.

Once the threshold speed/distance have been reached, the Bluetooth speaker 160 (which is in wireless electrical communication with the sensor 120 and detector 122) may alert the user that their vehicle is about to be rear-ended via an audible sound, tone, phrase, etc.

The camera 112 is in electrical communication with the sensor 120 and detector 122 such that the camera 112 may automatically begin recording any collision that may occur, including the events leading up to the collision. The Bluetooth transmitter 118 allows the recording from the camera 112 to be transferred to the smart device of the user for viewing. The transmitter 118 may also be a Wi-Fi transmitter in a different embodiment.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “rear vehicle light assistant device” and “device” are interchangeable and refer to the rear vehicle light assistant device 100 of the present invention.

Notwithstanding the foregoing, the rear vehicle light assistant device 100 of the present invention and its various components can be of any suitable size and configuration as is known in the art without affecting the overall concept of the invention, provided that they accomplish the above-stated objectives. One of ordinary skill in the art will appreciate that the size, configuration and material of the rear vehicle light assistant device 100 as shown in the FIGS. are for illustrative purposes only, and that many other sizes and shapes of the rear vehicle light assistant device 100 are well within the scope of the present disclosure. Although the dimensions of the rear vehicle light assistant device 100 are important design parameters for user convenience, the rear vehicle light assistant device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rear vehicle light assistant device comprising:
a light;
a sensor;
a speed detector;
a mount;
a mount base; and
a fastener.

2. The rear vehicle light assistant device of claim 1, wherein the light, the sensor, and the speed detector are in electrical communication.

3. The rear vehicle light assistant device of claim 1, wherein the sensor is comprised of a distance sensor.

4. The rear vehicle light assistant device of claim 1, wherein the fastener is comprised of an elastic band.

5. A rear vehicle light assistant device comprising:
a camera;
a light;
a sensor;
a speed detector;
a mount;
a mount base; and
a fastener comprised of a connector.

6. The rear vehicle light assistant device of claim 5, wherein the camera begins recording when a threshold distance of the sensor and a threshold speed of the speed detector has been reached or exceeded.

7. The rear vehicle light assistant device of claim 5, wherein the fastener is comprised of an elastic band.

8. The rear vehicle light assistant device of claim 7, wherein the connector is comprised of a hook or a loop surface that engages the fastener.

9. The rear vehicle light assistant device of claim 5, wherein the camera, the light, the sensor, and the speed detector are in electrical communication.

10. A rear vehicle light assistant device comprising:
a camera;
a light;
a sensor;
a speed detector;
a mount;
a mount base;
a fastener; and
a speaker.

11. The rear vehicle light assistant device of claim 10, wherein the speaker, the camera, the light, the sensor, and the speed detector are in electrical communication.

12. The rear vehicle light assistant device of claim 10, wherein the light begins blinking or flashing when a threshold distance of the sensor has been reached or exceeded.

13. The rear vehicle light assistant device of claim 10, wherein the light begins blinking or flashing when a threshold speed of the speed detector has been reached or exceeded.

14. The rear vehicle light assistant device of claim 10, wherein the speaker produces a sound, a tone, or a phrase when a threshold distance of the sensor has been reached or exceeded.

15. The rear vehicle light assistant device of claim 10, wherein the speaker produces a sound, a tone, or a phrase when a threshold speed of the speed detector has been reached or exceeded.

16. The rear vehicle light assistant device of claim 10, wherein the fastener of the rear vehicle light assistant device is comprised of a mount.

17. The rear vehicle light assistant device of claim 16, wherein the mount is received by a mount receiver on a body of the rear vehicle light assistant device.

18. The rear vehicle light assistant device of claim 10, wherein the camera, the light, the sensor, and the speed detector are powered by a battery.

19. The rear vehicle light assistant device of claim 10 further comprising a USB port.

20. The rear vehicle light assistant device of claim 10 further comprising a transmitter.
